(19) United States
(12) Patent Application Publication
(10) Pub. No.: US 2019/0270221 A1
(43) Pub. Date: Sep. 5, 2019

(54) FREEZE TAPE CASTING SYSTEMS AND METHODS

(71) Applicant: David R. Driscoll, Bozeman, MT (US)

(72) Inventor: David R. Driscoll, Bozeman, MT (US)

(21) Appl. No.: 16/290,476

(22) Filed: Mar. 1, 2019

Related U.S. Application Data
(60) Provisional application No. 62/638,141, filed on Mar. 3, 2018.

(51) Int. Cl. B28B 1/00; B29C 35/16

(52) U.S. Cl. CPC B28B 1/007; B29C 35/16

(57) ABSTRACT

A freeze tape casting system is provided that maximizes the production speed of a tape material with a directional porosity through a thickness of the tape material. Embodiments of the system may have multiple freeze zones where a freeze zone has a temperature profile and dwell time that is tailored to one or more parts of the physical process of freezing a solvent in the tape material to create the directional porosity. Various zones can be directed to physical processes such as nucleation, transitional crystal growth, steady crystal growth, maintaining the tape material in a frozen state, sublimating the frozen solvent, etc. As a result, the physical processes are decoupled from each other to maximize production speed. The resulting material has applicability in electrodes, current collectors, and other products.

### REFERENCE TO RELATED APPLICATION

The present application claims the benefit of U.S. Provisional Application Ser. No. 62/638,141, filed Mar. 3, 2018, which is incorporated herein by this reference in its entirety.

### FIELD

The disclosure relates generally to systems and methods for forming and controlling porosity in a material, and specifically, the disclosure relates to the formation and control of porosity in a material made from a freeze tape casting process.

### BACKGROUND

The porosity of a material affects the performance of the material, and some porosity characteristics are desirable for applications of the material. In batteries, for example, anisotropic or directional porosity is desirable for electrodes and current collectors to promote the flow of electrons in one or more directions but impede the flow of electrons in other directions. An electrode or current collector with such porosity can charge or recharge more quickly and efficiently. Therefore, materials with anisotropic porosity can be used in fuel cells, thermal interface materials, composites, battery electrodes, etc. while imparting analogous or entirely separate benefits.

Existing systems and processes can produce the material or materials used, for example, as a battery electrode. One process is tape casting where a slurry containing a ceramic powder, a solvent, and other additives such as binders and dispersants is cast onto a carrier film. The solvent allows the slurry to be deposited as a liquid onto the carrier film. Then, the slurry dries so that the solvent evaporates from the slurry and leaves behind a thin, solid film that can be used as a material in electrodes, current collectors, etc.

Another process is freeze tape casting where slurry having a solvent is frozen so that the solvent forms solid portions within the slurry. A sublimation process causes the frozen solvent to transition to a gaseous state, and the once-frozen solvent within the slurry now leaves pores within the residual solid. While these processes are known, there are several shortcomings. For instance, the casting rate for freeze tape casting is less than 10 mm per minute due to the physical processes of freezing such as nucleation, crystal growth, and particulate exclusion. In addition, there are few variables in existing processes to control, and therefore control the resulting pores in the material.

### SUMMARY

These and other needs are addressed by the various aspects, embodiments, and configurations of the present disclosure. Embodiments of the present disclosure can provide a process that combines tape casting and freeze casting in a freeze tape casting process to create desired porosity in a cast material and/or to maximize the speed at which the cast material can be produced. A common (e.g., single) conveyor belt or carrier film can transition from a tape casting process to a freeze casting process, and multiple freeze zones decouple the stages of solvent freezing in the feed material to maximize production speed. As a result, casting speeds can exceed 2-100 times prior art speeds, and more zones increases the number of controllable variables for more precise control of porosity in the cast material.

Growth of a freezing solvent through a thickness of the tape material is typically directed by a temperature gradient through the thickness. Once nucleation of frozen solvent crystals at a bottom surface of the tape material have been initiated, an applied temperature gradient can promote the growth of crystals of freezing solvent that are aligned with the growth direction through the thickness of the tape supporting the tape material. These crystals grow through the tape material at a rate, and the tape material moves through the zones at this same rate such that a substantially continuous freeze front of crystal growth is maintained in the tape material. One may assume that a steeper temperature gradient resulting in a faster crystal growth rate would result in a faster production speed, i.e., rate of the tape material moving through the zones. However, at a certain point, the physical processes of freezing the solvent break down, and the freezing solvent no longer excludes powders and other substances to form the desired pores. The resulting porosity is generally incomplete and undesirable. Similarly, drawing the carrier film too fast can result in the solvent freezing from spontaneous, heterogeneous nucleation rather than growing from existing crystals in the growth direction.

While not wishing to be bound by any theory, models have been developed to describe the freeze front in the material and the limits of the rate of freezing. Langer developed a model based on the work of Mullins and Sekerka which describes a critical freeze front velocity V_{C}:

$${V}_{C} = \frac{{DGL}_{V} K}{{k}_{B} {{T}_{f}^{2} ( 1 - K )}^{2}} \frac{1}{{C}_{∞}}$$

where D is the solute diffusion coefficient, G is the temperature gradient, Lᵥ is the latent heat of melting, T_{f} is the melting temperature, v is the specific volume, K is the partition coefficient describing the ratio of solute concentration in the solid phase and liquid phase, and c_{∞} is the concentration of solute in the fluid bulk. In addition, the Stokes-Einstein equation for an isolated particle can describe the effective diffusion coefficient (D(R)) of a colloid:

$$D ( R ) = \frac{{k}_{B} T}{6 π η R}$$

where k_{B} is Boltzmann's constant (1.38×10⁻²³ J/K), T is absolute temperature, η is the dynamic viscosity of the solvent and R is the particle radius. The implication of these relationships is that the maximum freezing rate which can be engineered in the freeze tape casting process is a function of, among other things, solvent thermophysical properties, slurry viscosity, and particle size. The upper limit of the temperature gradient is thus bounded. While the absolute magnitude of this critical velocity can vary widely according to a particular system, a lower bound may be 1's of microns/sec and an upper bound may be 1 mm/sec.

The above-described models and limits may apply to some but not all of the physical processes of freezing, which can include nucleation, transitional crystal growth, steady crystal growth, maintaining the tape material in a frozen state, sublimating the frozen solvent, etc.

Embodiments of the present invention can provide multiple freeze zones where each zone is tailored to one or more physical processes. Therefore, one or more, but not all, freeze zones may accommodate the above-described models and limits as necessary. The specific tailoring for a zone and physical process(es) can include different temperature profiles, or heat flux profiles, along the production direction, different dwell times in the zone, different temperature or humidity in the ambient environment, etc. Another benefit of embodiments of the present disclosure is that equipment may be specialized for a given zone, and therefore, the freeze tape casting system can be more efficient overall.

The present disclosure can provide a number of advantages depending on the particular configuration. For example, using multiple independently thermally controlled beds or zones, rather than one uniformly controlled bed or zone, can enable freeze casting to be done at a much higher rate than conventional freeze casting processes. While not wishing to be bound by any theory, independent control of the various beds can decouple the rate at which the freeze front moves up through the film from the velocity of the carrier film, thereby making the two parameters independent of one another. Independent control of the various beds can significantly reduce energy consumption without sacrificing energy efficiency. The freeze casting system can have dynamically configured independently controlled thermal zones to accommodate not just one by multiple different tape materials, each tape material having a different chemical composition and range of operating parameters to realize desired properties of the cast material. These and other advantages will be apparent from the disclosure of the aspects, embodiments, and configurations contained herein.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is an elevation view of an embodiment of the disclosure;

FIG. 2A is a cross-sectional elevation view of a tape and the embodiment in FIG. 1;

FIG. 2B is a detailed view of a portion of FIG. 2A;

FIG. 3A is a cross-sectional view of a tape produced by the embodiment of FIG. 1;

FIG. 3B is a top plan view of a tape produced by the embodiment of FIG. 1;

FIG. 4 is a further elevation view of the embodiment of FIG. 1;

FIG. 5 is a top plan view of freezing zones according to an embodiment of the disclosure;

FIG. 6 is a top plan view of freezing zones according to another embodiment of the disclosure;

FIG. 7 is a top plan view of freezing zones according to another embodiment of the disclosure;

FIG. 8 is a top plan view of freezing zones according to another embodiment of the disclosure;

FIG. 9A is a top plan view of freezing zones in a first arrangement according to another embodiment of the disclosure;

FIG. 9B is a top plane view of freezing zones in a second arrangement according to the embodiment in FIG. 9A; and

FIG. 10 depicts control logic for a freeze tape casting system according to an embodiment.

It should be understood that the diagrams are provided for example purposes only, and should not be read as limiting the scope of the disclosure. Many other configurations, including multiple working fluid injection points and/or use of multiple static mixers, are fully contemplated and included in the scope of the disclosure.

### DETAILED DESCRIPTION

### Freeze Tape Casting System

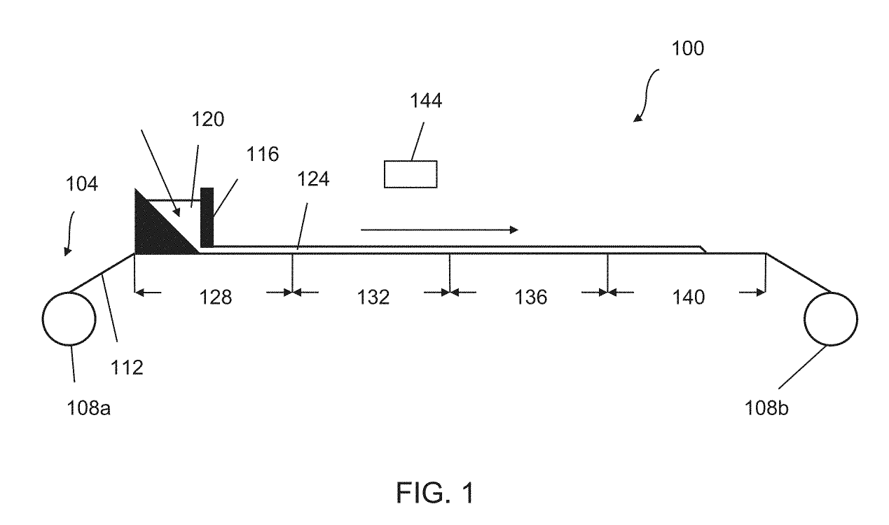

FIG. 1 depicts a freeze tape casting system 100 that combines tape casting and freeze casting and has several features that allow for the precise control of pores formed in a cast material and allow for a vastly-increased production rate of the cast material. The system 100 has a conveyor system 104 that comprises a first roller 108a, a second roller 108b, and a carrier film 112 extending between the rollers 108a, 108b. During production, the rollers 108a, 108b rotate to move the carrier film 112 along a production direction at a production speed or rate, and the carrier film 112 provides a planar surface along the various zones described in detail below. A casting area of the carrier film 112 can range between 20 in² to 500 ft² in some embodiments. The carrier film 112 may be made from a variety of materials including, but not limited to, biaxially-oriented polyethylene terephthalate (Mylar®), other polymer films, aluminum, or other metal foils. The carrier film 112 may be coated with another species to confer desirable physical or chemical properties.

A hopper and doctor blade 116 are positioned above the carrier film 112 and proximate to the first roller 108a. The hopper serves as a reservoir of a slurry 120 that has a particular composition, and the doctor blade 116 is set to a predetermined height above the carrier film 112. During production, the slurry 120 is deposited from the hopper, under the doctor blade, and onto the carrier film 112. The thickness of the slurry 120 is set by the doctor blade 116. As described below, the slurry 120 can have a variety of compositions based on the manufacturing process and the desired pore structure and desired material properties of the finished product.

Next, the carrier film 112 moves the slurry 120 as a tape material 124 in a production direction through a plurality of zones where the solvent freezes to form pores within the tape material 124. The first zone is a preset zone 128, which sets the temperature of the tape material 124 to a predetermined temperature or range of temperatures in anticipation of subsequent zones. For instance, a temperature in the preset zone 128 can control the temperature gradient through the planar direction of the tape material 124 or set up a large or small temperature gradient in the subsequent zone. Each zone may have a temperature profile, which is a series of temperatures along the production direction. A temperature profile may be constant where each temperature along the production direction is the same. Alternatively, a temperature profile may have varying temperatures along the production direction. In some embodiments, the preset zone 128 has a temperature profile above the freezing temperature of the solvent in the tape material.

In addition, the air above the tape material 124 may be conditioned in terms of temperature, humidity, or other characteristics to define a temperature profile or heat flux through the tape material or a solvent-loss rate out of the material. Further, the ambient environment above the tape material 124 can comprise other substances besides air such as an inert gas (e.g., molecular nitrogen) to suppress chemical reactions with substances in the tape material such as phosphorus or sodium. In some applications, the air temperature and humidity level of the ambient environment is substantially constant along the axial extents of the nucleation, transitional growth and steady state growth zones. When the solvent in the tape material is nonaqueous, the ambient environment can have a vapor pressure maintained at a level higher than the partial vapor pressure of the solvent under the temperature of the ambient environment to prevent or inhibit evaporation of the solvent from the tape material.

The next zone is a nucleation zone 132 where the temperature is set below the freezing temperature of the solvent in the tape material 124 to cause nucleation of ice crystals, typically in random orientations. The temperature, or alternatively the heat flux, is set in the nucleation zone 132 to transition the phase of the solvent from liquid to solid at a plurality of discrete locations within the tape material 124. Given that a freezing bed or cooling system is positioned beneath the carrier film 112, and the area above the tape material 124 is ambient air in some embodiments, a temperature gradient and/or heat flux is established across the thickness of the tape material 124. Therefore, nucleation preferentially occurs on the lower face of the tape material 124.

A transitional growth zone 136 is where most of the crystals of the freezing solvent transition from initial nucleation to ordered, directional growth (typically in a preferred direction that is a function of the preferred crystallographic direction for ice crystal growth and/or a growth direction along a temperature gradient that is substantially vertical through the plane of the tape material from the cold bed to the warmer ambient environment), whereby the crystals grow to a desired thickness (typically ranging from about 1 nm to about 25 microns). Initially, freezing solvent crystals grow asymmetrically along crystallographic axes, and the various solvent crystals are oriented in random directions so growth is disordered. However, crystal growth is promoted along temperature gradients. One temperature gradient in the freeze tape casting system is through the thickness of the tape material 124, which is the preferred direction of crystal growth. Therefore, growth is promoted along crystal axes, such as a c-axis, that are aligned with the temperature gradient. These favored crystals overtake the “misaligned” crystals to transition the initial nucleation to ordered growth in a preferred direction through the thickness of the tape material 124.

A steady growth zone 140 provides for the continued ordered growth of crystals in the preferred direction through the thickness of the tape material 124 to a desired final film thickness (typically ranging from about 25 microns to about 1 mm). With the freezing crystal growth already oriented in the preferred direction, the steady growth zone 140 can provide different shaped-pores in the tape material 124 as discussed in further detail below.

It will be appreciated that additional zones may be included in embodiments of the present invention. For example, zones positioned after the steady growth zone 140 may have temperature profiles that allow for the sublimation of the frozen solvent out of the tape material to leave behind directional pores through the thickness of the tape material 124. The freeze-drying process may be referred to as lyophilization, which can occur in a separate system than the freeze tape casting system in some embodiments. It will be further appreciated that some zones can be combined or divided. For example, nucleation and transitional growth may be combined into a single zone.

### Zone Temperature Profiles

It will be further appreciated that the zones can be defined in terms of relative differences. For instance, the average, mode or median temperature of the temperature profile for the preset casting zone is commonly greater than the corresponding average, mode or median temperature of the temperature profile for the nucleation zone. In some applications, the average, mode, or median temperature of the temperature profile for the preset casting zone is typically at least about 10 degrees Celsius, more typically at least about 50 degrees Celsius, and even more typically at least about 130 degrees Celsius more than the temperature of the corresponding average, mode, or median temperature profile for the nucleation zone. By way of reference, the average, mode, or median temperature of the temperature profile for the preset casting zone is typically at least about 0 degrees Celsius. The preset casting zone can be heated to drive a larger initial cooling rate.

The average, mode or median temperature of the temperature profile for the nucleation zone is commonly less than the corresponding average, mode or median temperature of the temperature profile for the next transitional growth zone. In some applications, the average, mode, or median temperature of the temperature profile for the nucleation zone is typically at least about 15 degrees Celsius, more typically at least about 25 degrees Celsius, and even more typically at least about 35 degrees Celsius less than the temperature of the corresponding average, mode, or median temperature profile for the transitional growth zone. In many applications, the average, mode, or median temperature of the temperature profile for the transitional growth zone ranges is commonly no more than the freezing point of the solvent in the tape material to about 40 degrees Celsius below the solvent freezing point. In many applications, the average, mode, or median temperature of the temperature profile for the nucleation zone commonly ranges from about 2 to about 100 degrees Celsius below the freezing point of the solvent in the tape material.

The average, mode or median temperature of the temperature profile for the transitional growth zone is commonly less than the corresponding average, mode or median temperature of the temperature profile for the next steady state growth zone. In some applications, the average, mode, or median temperature of the temperature profile for the transitional growth zone is typically at least about 30 degrees Celsius, more typically at least about 25 degrees Celsius, and even more typically at least about 15 degrees Celsius less than the temperature of the corresponding average, mode, or median temperature profile for the steady state growth zone. In many applications, the average, mode, or median temperature of the temperature profile for the steady state growth zone ranges is commonly no more than the freezing point of the solvent in the tape material to about 60 degrees Celsius below the solvent freezing point.

As will be appreciated, any number of independently thermally controlled zones can be included after the steady state growth zone depending on the application. In some applications, the nucleation and transitional growth zones are thermally controlled as a single zone.

### Zone Axial Lengths/Dwell Times

The various nucleation, transitional growth, and steady state growth zones can have the same or different axial lengths (along the production direction of the tape material) and/or dwell times of the tape material in the respective zone. In some applications, the axial length or dwell time of the tape material in the nucleation zone is commonly less than the axial length or dwell time of the tape material in the transitional growth zone, and the axial length or dwell time of the tape material in the transitional growth zone is commonly less than the axial length or dwell time of the tape material in the steady growth zone. In some applications, the axial length or dwell time of the tape material in the nucleation zone is typically no more than about 0.5%, more typically no more than about 10%, and even more typically no more than about 50% less than the axial length or dwell time of the tape material in the transitional growth zone, and the axial length or dwell time of the tape material in the transitional growth zone is typically no more than about 5%, more typically no more than about 40%, and even more typically no more than about 80% less than the axial length or dwell time of the tape material in the steady state growth zone. By way of reference, the axial length of the tape material in the steady growth zone is typically at least about 1 meter and no more than about 10 meters, and the dwell time of the tape material in the steady growth zone is typically at least about 30 seconds and no more than about 600 seconds.

The temperature profiles in any of the nucleation or steady growth zones can be relatively constant or variable depending on the application. In the former case, the minimum or maximum temperatures typically vary from the average, mode, or median temperature generally by no more than about 25 degrees Celsius and more generally by no more than about 40 degrees Celsius. In the latter case, the temperature profile for the zone generally increases (or has an upward slope or trend) from a first or initial temperature (as viewed by movement of the tape material) to a second or final temperature in the particular zone. In some applications, the final temperature is typically at least about 5 degrees Celsius and more typically at least about 20 degrees Celsius more than the first temperature. In some applications, however, the temperature profile for the zone can decrease (or has a downward slope or trend) from a first or initial temperature (as viewed by movement of the tape material) to a second or final temperature in the particular zone. In some applications, the final temperature is typically at least about 5 degrees Celsius and more typically at least about 20 degrees Celsius less than the first temperature.

### Tape Material

The tape material can have a variety of compositions to control the resulting porosity of the tape material as well as other selected characteristics of the tape material. For example, a slurry can be made from a powder of ceramic, metallic, or polymeric material, a solvent that will freeze to form pores, as well as a dispersant, a binder, a plasticizer, a defoamer, a surfactant, etc.

Due to the total elapsed time between slurry mixing and completion of freezing, even in a fast process, settling must be carefully considered. This limits large particle diameters which cannot be kept in suspension and are resistant to exclusion from advancing freeze fronts. Thickening agents such as xanthan gum can aid in preventing settling, but when used in excess can modify ice crystal formation and prevent particle exclusion from propagating crystals. In the extreme of minimum particle diameter, high specific surface areas cause difficulty in preventing agglomeration of powders. The powder may have a preferential size range between approximately 200 nanometers to 45 microns. This powder can be suspended in a solvent such as camphene, and this suspension is aided with the help of a dispersant such as oleic acid in concentrations typically ranging from about 0.1-5 wt %. The solids loading for this suspension may vary from about 3-60 wt %. A binder such as polyethylene glycol may be added in concentrations of about 2-30 wt %.

A number of processing additives can be necessary to produce green (formed, but not sintered) tapes of acceptable quality. While freeze tape casting is suited to a number of low melting temperature solvents, water may be an ideal solvent for this application because water freezes at reasonable temperatures and contrasts with other choices by being inexpensive and non-toxic. The percentage of water in a slurry is modified to achieve a defined “solids loading” as discussed below.

A commercial dispersant composed of proprietary ingredients is used for metals. Xanthan gum, effective in low concentrations of ˜0.5 wt % of powder mass, will also be utilized to increase slurry viscosity in low solids slurries, which helps prevent particle settling and helps high thickness tapes to maintain shape.

A surfactant is used at approximately 0.1% powder mass to improve wetting of the slurry on the silicone coated carrier film, particularly when thin tapes are desired as is the case here. Finally, a defoamer is used to aid in eliminating air bubbles from the slurry which would ultimately create flaws in the tape.

The ratio of subject powder to total slurry volume, or solids loading can be important depending on the application. Above all, solids loading in the initial slurry largely dictates the extent of open porosity, wall (strut) thickness, and contributes to the extent of grading. Typical casts are executed at about 15-20%, but casts have been made as low as about 7% and as high as about 50%.

### Porosity

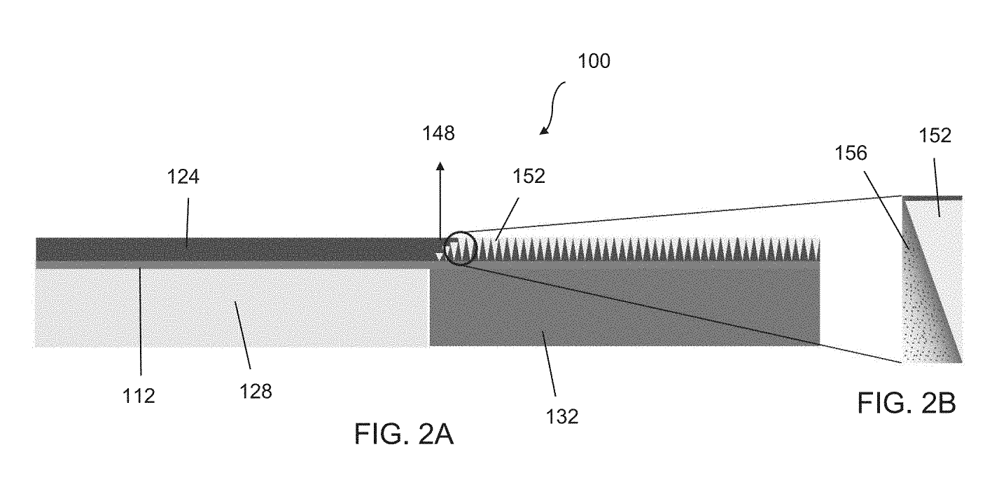

FIGS. 2A and 2B depict cross-sectional views of the tape material 124 as the initial nucleation of the solvent begins, and the growth of the freezing solvent extends in a preferred direction through the thickness of the tape material 124. FIG. 2A shows the tape material 124 moving in the production direction from left to right and from the preset zone 128 to the nucleation zone 132. After part of the tape material 124 enters the nucleation zone 132, the solvent in the tape material 124 nucleates at discrete locations on a bottom surface of the tape material 124. The freezing solvent 152 then extends upward in the growth direction 148 through the thickness of the tape material 124. FIG. 2B shows a detailed view of a freezing solvent 152 displacing other substances 156 of the tape material 124 as the solvent 152 freezes in the growth direction 148. Thus, when the solvent 152 eventually sublimates out of the tape material 124, pores are left behind where the frozen solvent 152 used to be located.

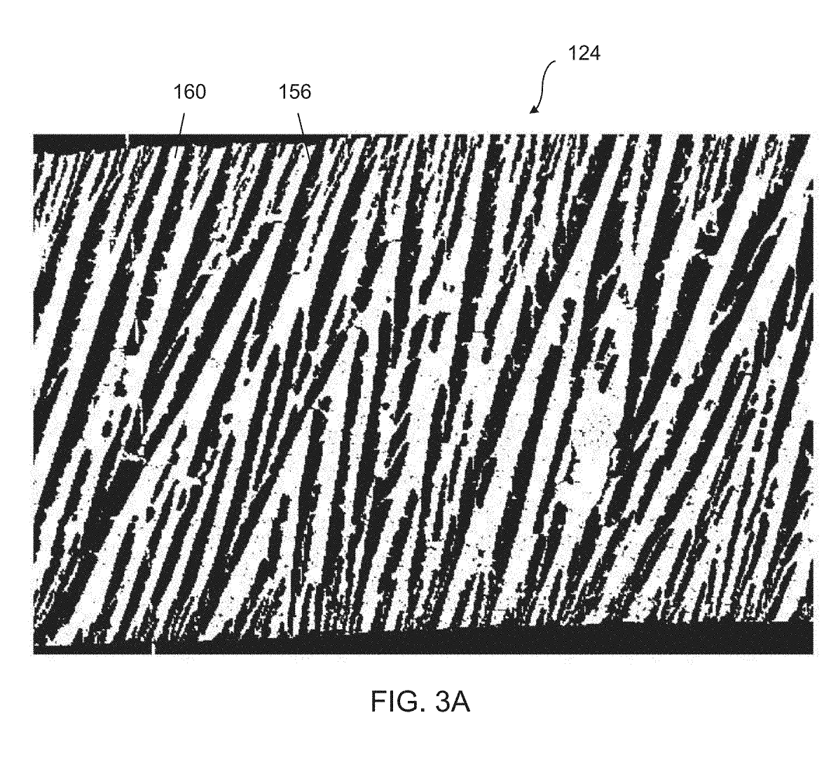

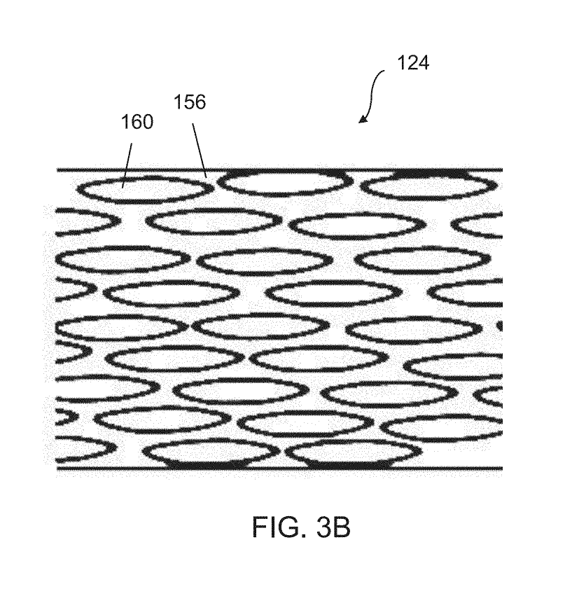

FIG. 3A depicts a cross-sectional view of the cast tape material 124 after the freeze tape casting process when the solvent is sublimated out of the tape material 124 to leave behind pores 160. The other portions of the tape material 156 include, for example, a ceramic powder, a binder, and/or any other materials discussed herein. In some embodiments, a high temperature sintering step burns out the binder and fuses individual particles to create a foam with microstructure similar to that shown in FIG. 3A. FIG. 3B shows a top plan view of the cast tape material 124 after the freeze casting process. The pores 160 have an oblong shape in some embodiments since the tape material 124 moves laterally in the production direction.

The resulting porosity in the tape material 124 can have a variety of characteristics. For example, the pores may have a substantially constant cross-sectional shape throughout the thickness of the tape material 124. In other embodiments, the temperature profile may cause a pore shape that expands as the solvent freezes through the thickness of the tape material 124 or produce an extruded V-shape with thousands of struts located between the pores as shown in FIG. 3A. The result is a porosity with low tortuosity that can be used as efficient electrodes and current collectors among other things.

### Control Unit

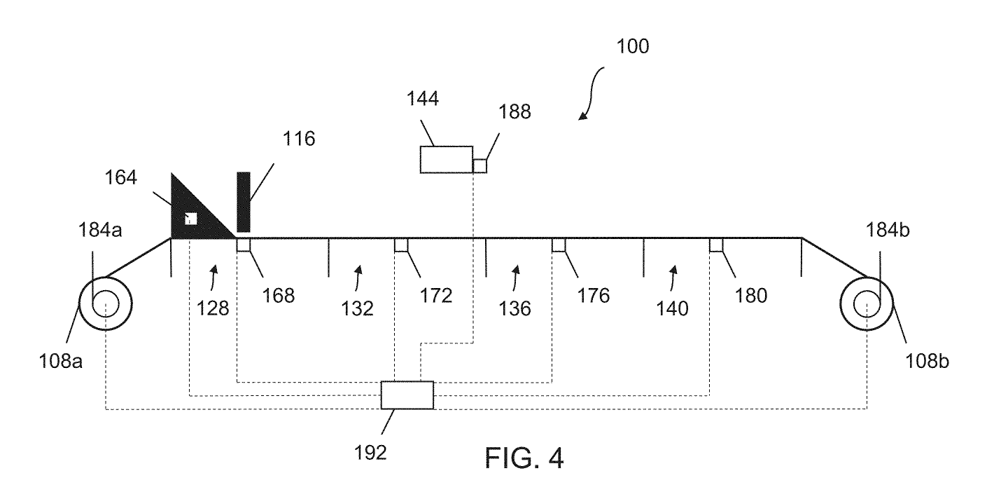

FIG. 4 depicts various sensors of the freeze tape casting system 100 and a control unit 192 that can receive readings from the sensors and can control components of the system 100. For example, each zone 128, 132, 136, 140 may have a respective temperature sensor 168, 172, 176, 180 or plurality of temperature sensors. Readings from these sensors 168, 172, 176, 180 provide the control unit 192 with information to determine current or initial temperature profiles of the zones 128, 132, 136, 140. The control unit may also receive temperature and/or humidity readings from a sensor 188 above the carrier film and tape material, temperature readings from a sensor 164 associated with the hopper and doctor blade 116, and movement readings from sensors 184a, 184b in the rollers 108a, 108b. As described in further detail below, the control unit 192 can receive readings; determine what temperature profiles, carrier film speed, doctor blade height, etc. are needed to produce the desired porosity in the tape material; and then orchestrate various systems to create the necessary temperature gradients, heat fluxes, ambient gas characteristics, etc. to realize the desired porosity in the tape material. The control unit may include a proportional-integral-derivative (PID) controller to control the temperature and other aspects of the freeze tape casting system. For example, a PID controller could control the temperature profiles as described herein in response to the production rate, the thickness of the tape material, the composition of the slurry, etc.

### Cooling System

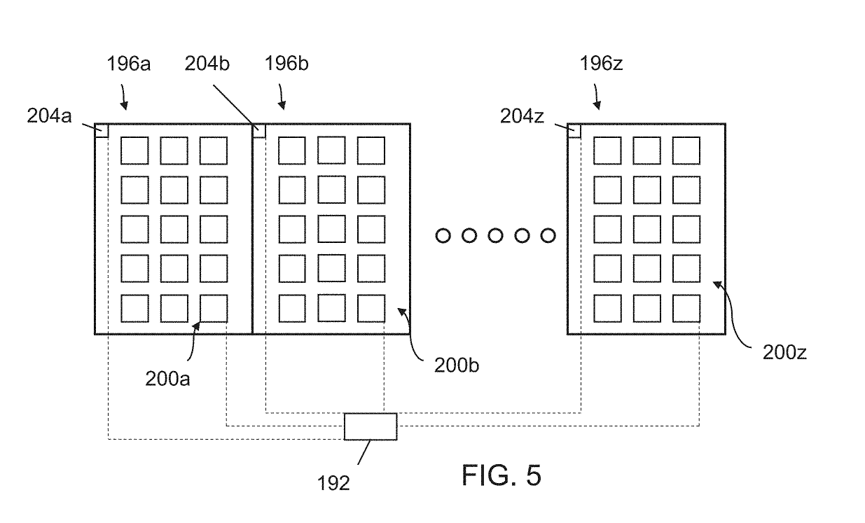

FIGS. 5-9B show various exemplary cooling systems. FIG. 5 shows a top plan view of a cooling system that has generic zones 196a, 196b, . . . 196z from left to right in the production direction. Each zone 196 has at least one thermoelectric cooler 200 and a respective temperature sensor 204. As shown, each temperature sensor 204 provides readings to the control unit 192, and the control unit 192 can then cause the thermoelectric coolers 200 to establish temperature profiles for the zones 196. It will be appreciated that in some embodiments there may be a plurality of temperature sensors 204 (such as each thermoelectric cooler corresponding to a proximal set of one or more temperature sensors), and the control unit can model the current temperature profile of each zone 196 based on the readings from the temperature sensors 204.

The thermoelectric coolers 200 in a given zone may be commonly controlled. For example, the plurality of thermoelectric coolers 200a in the first zone 196a may receive a single voltage signal, and each cooler 200a produces the same heat flux. In addition, each different zone 196 may be independently controlled. For example, the first zone 196a may receive a first voltage signal and the second zone 196b may receive a second voltage signal to establish different temperature profiles or heat fluxes in different zones 196a, 196b. Further still, each thermoelectric cooler 200 in a given zone may be independently controlled to produce varying temperature profiles or heat fluxes in a single zone 196.

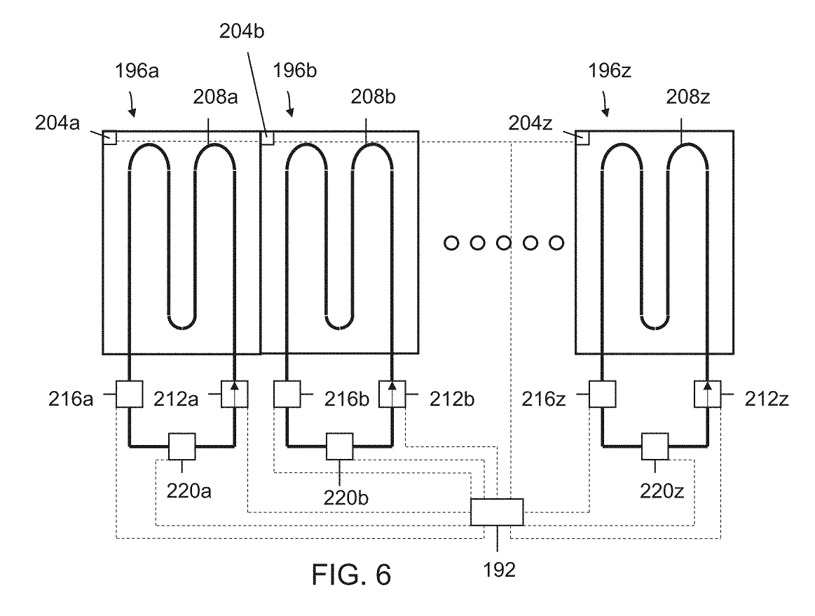

FIG. 6 shows an embodiment of the cooling system that has a cooling loop 208 for each zone 196. Each cooling loop 208 has a pump 212 that circulates coolant through the loop 208 and has a refrigeration unit 216 to condition the coolant. The refrigeration unit 216 may utilize any type of refrigeration cooling cycle such as a vapor-compression cycle, a vapor absorption cycle, a gas cycle, a Stirling engine, a reversed Carnot cycle, etc. Alternatively or in addition, warm and cool sources of coolant can be mixed at a specified ratio. During operation, the control unit 192 can independently control each zone 196. For example, the control unit 192 can direct the first pump 212a to circulate the coolant at a predetermined rate and direct the first refrigeration unit 216a to reduce the temperature of the coolant by a predetermined amount to produce the desired temperature profile or heat flux in the first zone 196a. It will be appreciated that the coolant may increase in temperature as the coolant circulates through the loop 208, and therefore, the coolant may enter at a leading end of the zone 196 or a trailing end of the zone 196 to establish an increasing or decreasing temperature profile.

An optional reservoir 220 of coolant is provided for each zone 196. It will be appreciated that in some embodiments, no reservoir 220 is provided, and a constant amount of coolant is circulated through each loop 196. Alternatively, one set of zones can be cooled by a thermoelectric refrigeration unit and another set of zones can be cooled by another refrigeration technique. In some applications, one or more of the zones can be cooled by a cryocooler.

Also shown in FIG. 6 are various exemplary control lines providing communication between sensors 204 and a control unit 192 and between the control unit 192 and the various components 212, 216, 220 for each loop 196 of the cooling system. The control unit may receive readings from various sensors to determine the current state (temperature profiles, heat flux profiles, etc.) of each zone 196, determine the required state of each zone 196 to produce the desired porosity through the tape material, and then direct or cause the components to generate the required state of each zone 196.

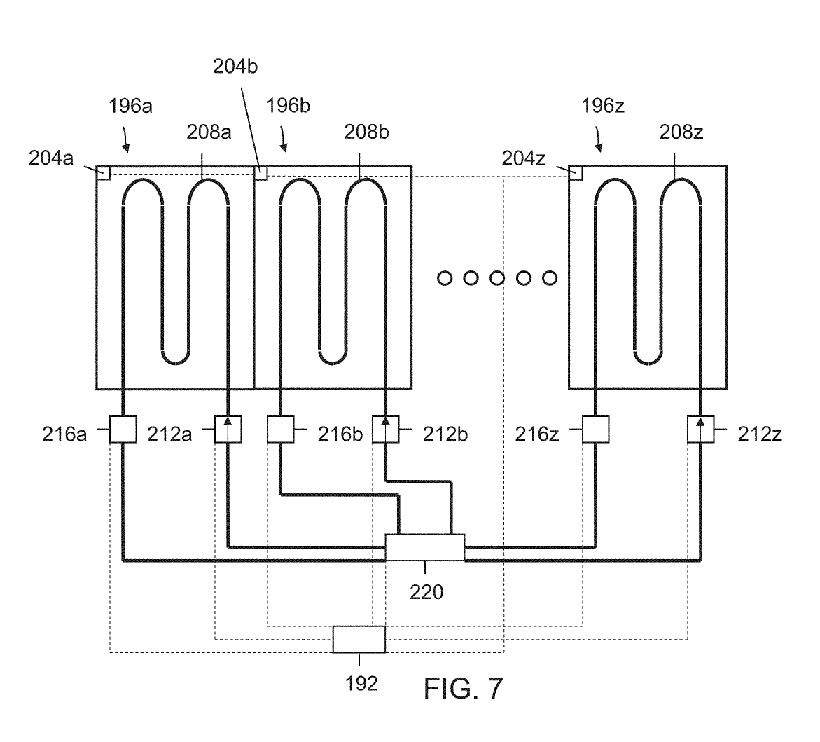

FIG. 7 depicts another embodiment of the cooling system where the loops 208 of the zones 196 share a common reservoir 220 but each loop has a separate refrigeration unit 216 and pump 212. Again, a control unit 192 may control components 212, 216, 220 for each loop 208 of the cooling system. For example, during operation, the control unit 192 can direct the first pump 212a to draw the coolant from the reservoir 220 at a predetermined rate and direct the first refrigeration unit 216a to reduce the temperature of the coolant by a predetermined amount to produce the desired temperature profile or heat flux in the first zone 196a. It will be appreciated that the refrigeration unit 216a may be positioned between the first pump 212a and the reservoir 220 to condition the coolant prior to entering the first zone 196a.

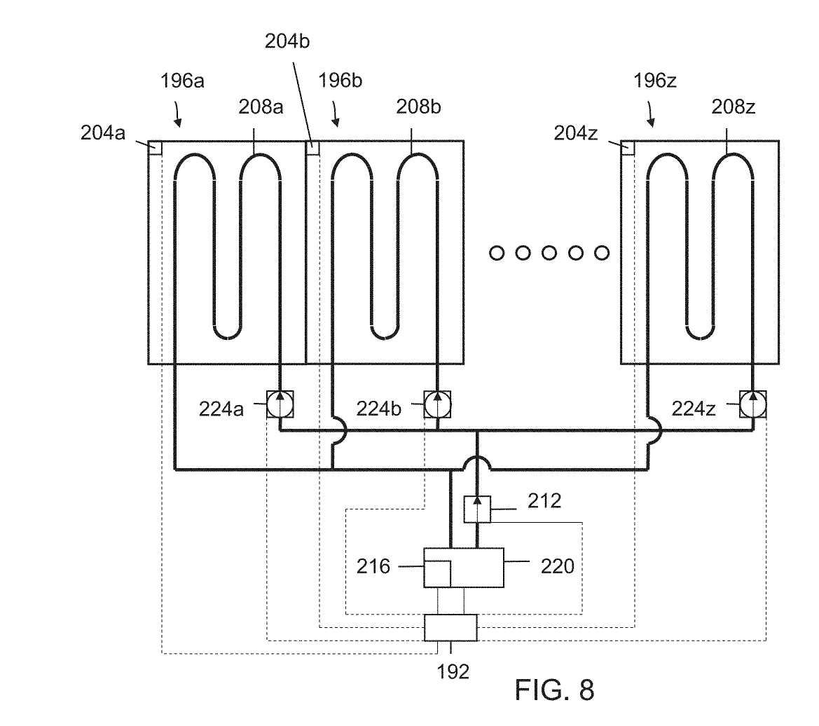

Similarly, FIG. 8 depicts an embodiment of the cooling system where the loops 208 for the zones 196 share a common pump 212, refrigeration unit 216, and reservoir 220 but uses a series of valves 224 to selectively direct the cooling or working fluid in various zones 196. In this embodiment, once the zones 196 and respective temperature profiles have been established, the control unit 192 can set the pump 212 to draw coolant from the reservoir 220 at a predetermined rate and direct the refrigeration unit 216 to condition the coolant in the reservoir 220 to a predetermined temperature. Next, the control unit 192 can direct the valves 224, which may be variably-controlled, to allow a predetermined flow rate of coolant through the respective zones 196. Therefore, a first valve 224a can set a lower flow rate to establish a first temperature profile in the first zone 196a, and a second valve 224b can set a higher flow rate to establish a second, cooler temperature profile in the second zone 196b. Examples of variably-controlled valves 224 may include gate valves, globe valves, pinch valves, pintle valves, diaphragm valves, and needle valves.

It will be appreciated that the control unit 192 may receive various readings and inputs such as substances in the tape material, tape thickness, desired porosity, etc. and then determine and execute the required temperature profile, moving rate of the carrier film, number of zones, dwell time for each zone, the substance or substances in the ambient gas, temperature of the ambient gas, humidity of the ambient gas, etc. In other embodiments, a user may manually input the temperature profiles, moving rates, etc. In further embodiments, the control unit 192 may communicate via a network, such as the Internet, with a remote server that can determine the required temperature profiles and other settings for a specified tape material and/or cast material and/or provide preset temperature profiles and other settings to the control unit 192.

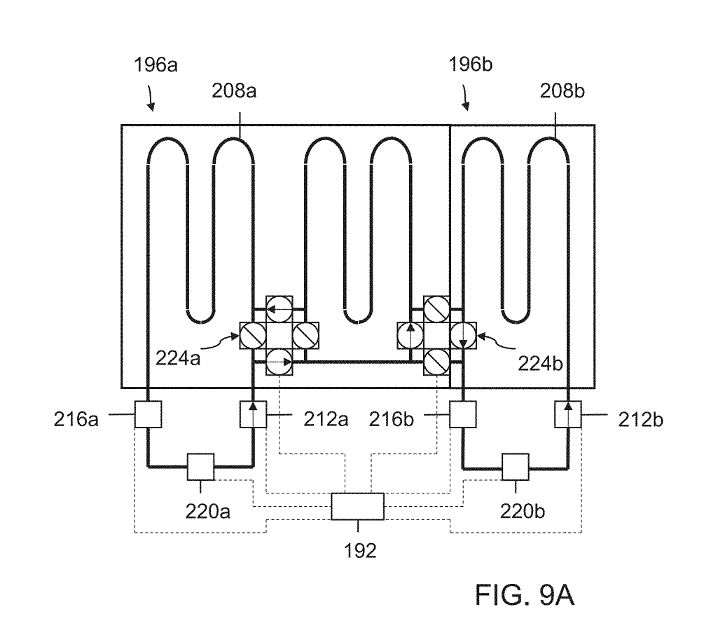

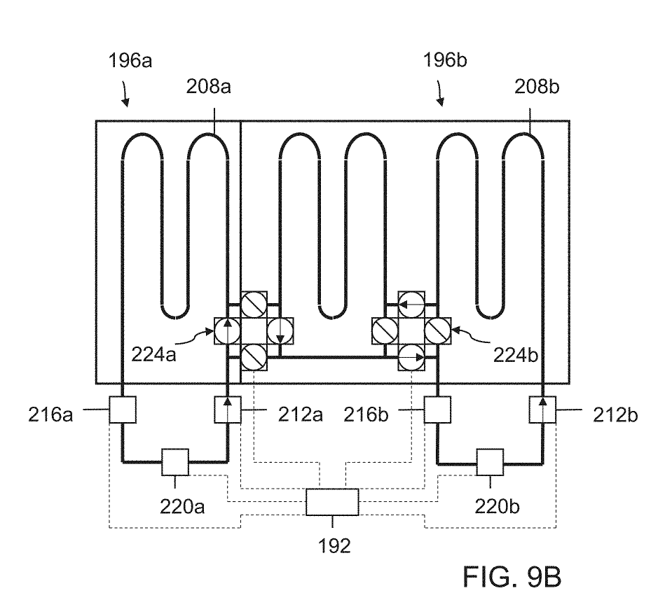

FIGS. 9A and 9B show a top plan view of an embodiment of the freeze tape casting system and the cooling system that can change the axial length of a given zone 196 to change the amount of time that a given point on the tape material dwells in the zone, or dwell time. As shown, two pluralities of valves 224a, 224b allow the first loop 208a in the first zone 196a and the second loop 208b in the second zone 196b to change axial lengths in the production direction. The first set of valves 224a has two valves open and two valves closed to allow coolant in the first loop 208a to circulate through the middle portion. Conversely, the second set of valves 224b has two valves open and two valves closed to prevent coolant in the second loop 208b from circulating in the middle portion. In this sense, the axial length of the first zone 196a has increased, and the axial length of the second zone 196b has been reduced. FIG. 9B shows the valves 224a, 224b in an opposite configuration where the axial length of the second zone 196b has been increased and coolant that flows through the second zone 196b flows through the middle portion, and the axial length of the first zone 196a has been reduced. Examples of on/off valves 224 may include ball valves, butterfly valves, and gate/sluice valves. It will be further appreciated that the exemplary embodiment in FIGS. 9A and 9B may utilize variably-controlled valves 224, and the exemplary embodiment in FIG. 8 may utilize on/off valves 224.

### Control Logic

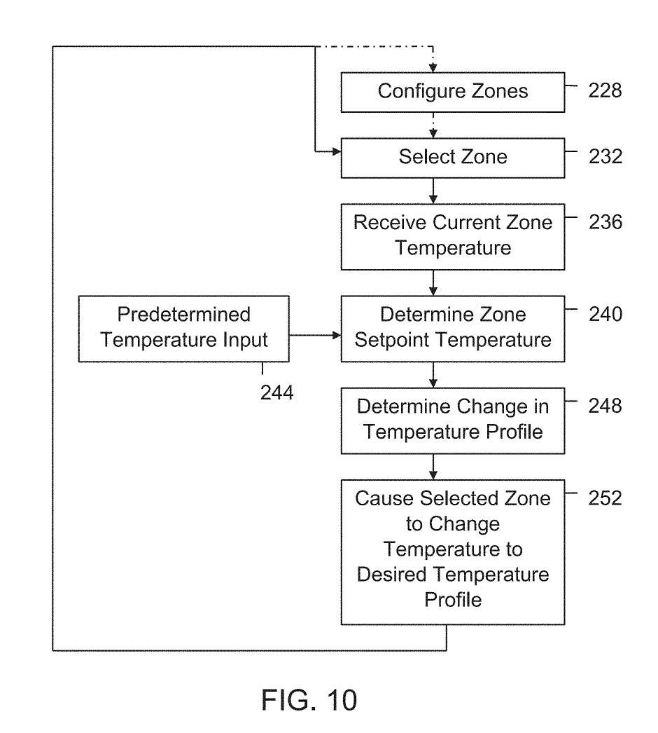

FIG. 10 depicts an exemplary control logic flow diagram for embodiments of the freeze tape casting system. A control unit as described herein can execute instructions causing the performance of some or all of these actions, and alternatively, some or all of these actions can be performed by another (remotely located) computer system or user. In addition, these actions may be performed simultaneously or in a different order.

To begin, the various zones are configured 228, and this configuration may be optional if the zones are already configured or have fixed configurations. This configuration may first begin with initial parameters of the freeze tape casting process. For example, the initial parameters may include the composition of the tape material, the desired porosity in the tape material, the thickness of the tape material, the desired production rate, etc. Based on these initial parameters, the control unit or other device can begin to model the freeze tape casting system including the number of zones and the axial length (dwell time) for each zone. The control unit may determine axial lengths (dwell times) for a preset zone, a nucleation zone, a transition zone, and a steady growth zone that are necessary to produce a tape material with characteristics dictated by the initial parameters. In an example of the steady growth zone, the initial parameters may include a material composition with a freeze rate of 50 microns/s, a tape thickness of 500 microns, a desired production rate of 10 cm/s. Thus, 10 seconds of dwell time is needed to freeze through the thickness of the tape material, and if the production rate is 10 cm/s, then the axial length of the zone is 100 cm.

Then, one of the plurality of zones is selected 232 and a reading from a temperature sensor in the selected zone is received 236. The reading may be at a predetermined position in the selected zone, and then, for example, the control unit can determine the current temperature profile of the selected zone. The temperature profile extends in at least one direction, specifically the production direction, but may also include other directions as well.

Next, a setpoint temperature for the selected zone is determined 240. This setpoint temperature can be determined by the control unit and based on the initial parameters. As discussed herein, the zones may correspond to one or more physical processes of freezing the solvent in the tape material. For example, based on the composition of the tape material, the desired porosity in the tape material, the thickness of the tape material, the desired production rate, etc., the control unit may determine a particular temperature profile for the steady growth zone. Alternatively, a predetermined temperature input 244 may be utilized. This predetermined temperature input 244 may be manually entered by a user, retrieved from a remote database, or otherwise not determined by the control unit. For example, the temperature profile in the steady growth zone can range between below the freezing point of the solvent in the tape material to 60 degrees Celsius below the freezing point.

The control unit may then determine the change in temperature profile 248 from the current temperature profile to the setpoint temperature profile, and cause 252 the various components of the freeze tape casting system to change the temperatures of the zones to produce and maintain the final temperature profiles. For example, referring to FIG. 5, the control unit may direct the thermoelectric coolers 200 to change the temperature profiles of each zone 196 from the current temperature profiles to the setpoint temperature profiles. Then, the control unit will need to direct the thermoelectric coolers 200 to maintain the desired temperature profile or heat flux in the respective zones 196. A PID controller, as discussed above, can account for heat energy drawn from each zone 196 into the moving tape material and adjust the thermoelectric coolers 200 to account for these dynamic conditions. It will be appreciated that the control unit and/or PID control, which may be part of the control unit, can control pumps, refrigeration units, valves, etc. as necessary to perform the actions in FIG. 10.

The control logic can then be performed for each configured zone to establish the necessary temperature profiles. It will be appreciated that the control unit can perform actions in various orders or simultaneously. For example, the control unit can determine and cause the freeze tape casting system to establish temperature profiles in the various zones in serial order. Alternatively, the control unit can determine the temperature profiles in the various zones and then cause the freeze tape casting system to establish the temperature profiles simultaneously. In addition, the freeze tape casting system may determine the required production rate, and thus, moving rate of the carrier film and the associated rollers, but only cause the rollers to rotate in response to an input such as weight of the slurry in the hopper and/or the carrier film, etc.

The present disclosure, in various aspects, embodiments, and configurations, includes components, methods, processes, systems and/or apparatus substantially as depicted and described herein, including various aspects, embodiments, configurations, subcombinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Embodiments can include systems and methods having:

a carrier film moving in a production direction;

a slurry having a solvent, the slurry deposited onto the moving carrier film to form a tape material;

a nucleation zone extending a first distance along the production direction, and the nucleation zone providing a nucleation temperature profile beneath the carrier film to initiate nucleation of the solvent from a liquid phase to a solid phase at a plurality of discrete locations in the tape material; and

a steady growth zone extending a second distance along the production direction and positioned after the nucleation zone in the production direction, and the steady growth zone providing a steady growth temperature profile beneath the carrier film to continue freezing of the solvent from at least one of the plurality of discrete locations in a growth direction through a thickness of the tape material, wherein the nucleation temperature profile is distinct from the steady growth temperature profile, and the first distance is distinct from the second distance.

Some embodiments of the systems and methods can further comprise a transition zone extending a third distance along the production direction and positioned between the nucleation zone and the steady growth zone along the production direction, and the transition zone having a transition temperature profile to promote freezing of the solvent from at least one of the plurality of discrete locations in the growth direction over other directions, wherein the transition temperature profile is distinct from the nucleation temperature profile and distinct from the steady growth temperature profile, and the third distance is distinct from the first distance and distinct from the second distance.

Various embodiments of the systems and methods can further comprise a cooling system positioned beneath the carrier film in the nucleation zone, wherein the cooling system generates the nucleation temperature profile. In some embodiments of the systems and methods, the cooling system comprises a pump that moves a coolant fluid through a loop. In various embodiments of the systems and methods, the cooling system comprises a plurality of thermoelectric coolers. In some embodiments of the systems and methods, the solvent is water, and the nucleation temperature profile is between −2 and −150 degrees Celsius. In various embodiments of the systems and methods, the solvent is water, and the steady growth temperature profile is between 0 and −60 degrees Celsius. In some embodiments of the systems and methods, the nucleation temperature profile varies along the first distance in the production direction.

Embodiments can include systems and methods having:

moving a carrier film in a production direction;

depositing a slurry onto the carrier film at a predetermined thickness to form a tape material having a solvent;

initiating nucleation of the solvent from a liquid phase to a solid phase at a plurality of discrete locations in the tape material by moving the carrier film and the tape material through a nucleation zone having a nucleation heat flux applied by a first cooling component;

freezing the solvent from at least one of the plurality of discrete locations in a growth direction through the thickness of the tape material by moving the carrier film and the tape material through a steady growth zone having a steady growth heat flux applied by a second cooling component, wherein the applied steady growth heat flux is different from the applied nucleation heat flux; and

removing the solvent from the tape material to leave pores oriented along the growth direction in the tape material.

In some embodiments of the systems and methods, frozen solvent is removed from the tape material by sublimation.

Embodiments can include systems and methods having:

detecting, by a temperature sensor, a temperature of the nucleation zone used to determine an initial nucleation heat flux;

determining, by a control unit, a final nucleation heat flux based on the solvent of the tape material and the thickness of the tape material; and

causing, by the control unit, a cooling system to change the initial nucleation heat flux to the final nucleation heat flux.

Embodiments can include systems and methods having:

providing at least one roller in operable communication with a control unit, wherein the at least one roller is connected to the carrier film to move the carrier film in the production direction;

receiving, by the control unit, an initial rotation speed of the at least one roller;

determining, by the control unit, a final rotation speed of the at least one roller such that the carrier film moves at a predetermine rate, and a given point of the tape material moves through the nucleation zone for a nucleation dwell time and moves through the steady growth zone for a steady growth dwell time; and

causing, by the control unit, the at least one roller to change the initial rotation speed to the final rotation speed.

Embodiments can include systems and methods having:

detecting, by a temperature sensor, an initial temperature of an ambient gas above the carrier film and the tape material;

determining, by a control unit, a final temperature based on the solvent of the tape material and the thickness of the tape material; and

causing, by the control unit, an ambient control unit to change the initial temperature to the final temperature and establish the nucleation heat flux through the thickness of the tape material in the nucleation zone and the steady growth heat flux through the tape material in the steady growth zone.

Embodiments can include systems and methods having:

a control unit programmed to independently control a temperature profile of a first zone and a temperature profile of a second zone;

a first temperature sensor in operable communication with the control unit, the first temperature sensor detects a temperature that is part of an initial first temperature profile in the first zone;

a second temperature sensor in operable communication with the control unit, the second temperature sensor detects a temperature that is part of an initial second temperature profile in the second zone;

a cooling system in operable communication with the control unit, the cooling system positioned beneath a carrier film in the first and second zones;

instructions that, when executed by the control unit, cause the control unit to:

receive the temperature that is part of the initial first temperature profile in the first zone;

determine a final first temperature profile based on a solvent in a tape material on the carrier film;

cause the cooling system to change the initial first temperature profile to the final first temperature profile in the first zone;

receive the temperature that is part of the initial second temperature profile in the second zone;

determine a final second temperature profile based on the solvent in the tape material on the carrier film;

cause the cooling system to change the initial second temperature profile to the final second temperature profile in the second zone.

In some embodiments of the systems and methods, the cooling system comprises a first coolant loop positioned beneath the carrier film in the first zone and a second coolant loop positioned beneath the carrier film in the second zone.

In various embodiments of the systems and methods, the first zone is a nucleation zone, and the final first temperature profile initiates nucleation of the solvent from a liquid phase to a solid phase at a plurality of discrete locations in the tape material, wherein the second zone is a steady growth zone, and the final second temperature profile continues freezing of the solvent from at least one of the plurality of discrete locations in a growth direction through a thickness of the tape material.

Embodiments can include systems and methods having:

an ambient temperature sensor in operable communication with the control unit; the ambient temperature sensor detects an initial ambient temperature of an ambient gas above the carrier film and the tape material;

an ambient control unit in operable communication with the control unit, the ambient control unit positioned above the carrier film and the tape material;

instructions that, when executed, cause the control unit to:

receive the initial ambient temperature from the ambient temperature sensor;

determine a final ambient temperature based on the solvent in the tape material on the carrier film;

cause the ambient control unit to change the initial ambient temperature of the ambient gas to the final ambient temperature of the ambient gas and establish a first temperature gradient through the thickness of the tape material in the first zone and a second temperature gradient through the tape material in the second.

In various embodiments of the systems and methods, the control unit determines the initial first temperature profile.

Embodiments can include systems and methods having:

at least one roller in operable communication with the control unit, wherein the at least one roller is connected to the carrier film to move the carrier film in a production direction;

instructions that, when executed, cause the control unit to:

receive an initial roller speed from the at least one roller;

determine a final roller speed based on the solvent in the tape material on the carrier film;

cause the at least one roller to change the initial roller speed to the final roller speed.

Embodiments can include systems and methods having:

instructions that, when executed, cause the control unit to:

receive the final first temperature profile;

determine a dwell time for the tape material in the first zone;

cause the cooling system to change an axial length of the first zone along a production direction.

The following definitions are used in this disclosure.

“A” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁—Xₙ, Y₁—Yₘ, and Z₁—Z₀, the phrase is intended to refer to a single element selected from X, Y, and Z, a combination of elements selected from the same class (e.g., X₁ and X₂) as well as a combination of elements selected from two or more classes (e.g., Y₁ and Z₀).

The term “automatic” and variations thereof refer to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” refers to any computer-readable storage and/or transmission medium that participate in providing instructions to a processor for execution. Such a computer-readable medium can be tangible, non-transitory, and non-transient and take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “computer readable storage medium” may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may be any computer readable medium that is not a computer readable storage medium and that can communicate, propagate, or transport a program for use by or in connection with an instruction execution system, apparatus, or device. A computer readable signal medium may convey a propagated data signal with computer readable program code embodied therein, for example, in baseband or as part of a carrier wave. Such a propagated signal may take any of a variety of forms, including, but not limited to, electromagnetic, optical, or any suitable combination thereof. Program code embodied on a computer readable signal medium may be transmitted using any appropriate medium, including but not limited to wireless, wireline, optical fiber cable, RF, etc., or any suitable combination of the foregoing.

A “cryocooler” refers to a cooling unit that can cool to cryogenic temperatures. Exemplary cooling units include Stirling refrigerators, Gifford-McMahon coolers, pulse-tube refrigerators, and Joule-Thomson coolers.

The terms “determine”, “calculate” and “compute,” and variations thereof, are used interchangeably and include any type of methodology, process, mathematical operation or technique.

The term “heat flux” sometimes also referred to as heat flux density or heat flow rate intensity is a flow of energy per unit of area per unit of time. In SI its units are watts per square meter (W·m−2). It may have both a direction and a magnitude, and so may be a vector quantity. To define the heat flux at a certain point in space, one may take the limiting case where the size of the surface becomes infinitesimally small.

“Means” shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

The term “module” refers to any known or later developed hardware, software, firmware, artificial intelligence, fuzzy logic, or combination of hardware and software that is capable of performing the functionality associated with that element.

“Refrigeration” is a process of removing heat from a low-temperature reservoir and transferring it to a high-temperature reservoir. The work of heat transfer is traditionally driven by mechanical means, but can also be driven by heat, magnetism, electricity, laser, or other means. Refrigeration methods include cyclic refrigeration (a refrigeration cycle, where heat is removed from a low-temperature space or source and rejected to a high-temperature sink with the help of external work, and its inverse, the thermodynamic power cycle), the vapor-compression cycle (in which a circulating refrigerant such as Freon enters a compressor as a vapor. the vapor is compressed at constant entropy and exits the compressor as a vapor at a higher temperature, but still below the vapor pressure at that temperature, the vapor travels through the condenser which cools the vapor until it starts condensing, then condenses the vapor into a liquid by removing additional heat at constant pressure and temperature, and the liquid refrigerant goes through the expansion valve (also called a throttle valve) where its pressure abruptly decreases, causing flash evaporation and auto-refrigeration of, typically, less than half of the liquid), the vapor absorption cycle (which is similar to the compression cycle, except for the method of raising the pressure of the refrigerant vapor; that is, in the absorption system, the compressor is replaced by an absorber which dissolves the refrigerant in a suitable liquid, a liquid pump which raises the pressure and a generator which, on heat addition, drives off the refrigerant vapor from the high-pressure liquid), the gas cycle (when the working fluid is a gas (such as air) that is compressed and expanded but does not change phase, the refrigeration cycle is called a gas cycle; as there is no condensation and evaporation intended in a gas cycle, components corresponding to the condenser and evaporator in a vapor compression cycle are the hot and cold gas-to-gas heat exchangers in gas cycles), magnetic refrigeration (a cooling technology based on the magnetocaloric effect, an intrinsic property of magnetic solids, in which a refrigerant, such as a paramagnetic salt (e.g., cerium magnesium nitrate) is subjected to a strong magnetic field forcing its various magnetic dipoles to align and putting these degrees of freedom of the refrigerant into a state of lowered entropy; a heat sink then absorbs the heat released by the refrigerant due to its loss of entropy; and thermal contact with the heat sink is then broken so that the system is insulated, and the magnetic field is switched off, thereby increasing the heat capacity of the refrigerant, thus decreasing its temperature below the temperature of the heat sink), elastocaloric refrigeration, fridge gate, and thermoelectric cooling.

“Thermoelectric cooling” commonly uses the Peltier effect to create a heat flux between the junction of two different types of materials. A Peltier cooler, heater, or thermoelectric heat pump is a solid-state active heat pump which transfers heat from one side of the device to the other, with consumption of electrical energy, depending on the direction of the current. Such an instrument is also called a Peltier device, Peltier heat pump, solid state refrigerator, or thermoelectric cooler (TEC). It can be used either for heating or for cooling,^{[1]} although in practice the main application is cooling. It can also be used as a temperature controller that either heats or cools. Two unique semiconductors, one n-type and one p-type, are used because they need to have different electron densities. The semiconductors are placed thermally in parallel to each other and electrically in series and then joined with a thermally conducting plate on each side. When a voltage is applied to the free ends of the two semiconductors there is a flow of DC current across the junction of the semiconductors causing a temperature difference. The side with the cooling plate absorbs heat which is then moved to the other side of the device where the heat sink is. Thermoelectric Coolers, also abbreviated to TECs are typically connected side by side and sandwiched between two ceramic plates. The cooling ability of the total unit is then proportional to the number of TECs in it.

We claim:

1. A freeze tape casting system, comprising:
a carrier film moving in a production direction;
a slurry having a solvent, the slurry deposited onto the moving carrier film to form a tape material;
a nucleation zone extending a first distance along the production direction, and the nucleation zone providing a nucleation temperature profile beneath the carrier film to initiate nucleation of the solvent from a liquid phase to a solid phase at a plurality of discrete locations in the tape material; and
a steady growth zone extending a second distance along the production direction and positioned after the nucleation zone in the production direction, and the steady growth zone providing a steady growth temperature profile beneath the carrier film to continue freezing of the solvent from at least one of the plurality of discrete locations in a growth direction through a thickness of the tape material, wherein the nucleation temperature profile is distinct from the steady growth temperature profile, and the first distance is distinct from the second distance.

2. The freeze tape casting system of claim 1, further comprising:
a transition zone extending a third distance along the production direction and positioned between the nucleation zone and the steady growth zone along the production direction, and the transition zone having a transition temperature profile to promote freezing of the solvent from at least one of the plurality of discrete locations in the growth direction over other directions, wherein the transition temperature profile is distinct from the nucleation temperature profile and distinct from the steady growth temperature profile, and the third distance is distinct from the first distance and distinct from the second distance.

3. The freeze tape casting system of claim 1, further comprising:
a cooling system positioned beneath the carrier film in the nucleation zone, wherein the cooling system generates the nucleation temperature profile.

4. The freeze tape casting system of claim 3, wherein the cooling system comprises a pump that moves a coolant fluid through a loop.

5. The freeze tape casting system of claim 3, wherein the cooling system comprises a plurality of thermoelectric coolers.

6. The freeze tape casting system of claim 1, wherein the solvent is water, and the nucleation temperature profile is between −2 and −150 degrees Celsius.

7. The freeze tape casting system of claim 1, wherein the solvent is water, and the steady growth temperature profile is between 0 and −60 degrees Celsius.

8. The freeze tape casting system of claim 1, wherein the nucleation temperature profile varies along the first distance in the production direction.

9. A method for forming pores in a tape material, comprising:
moving a carrier film in a production direction;
depositing a slurry onto the carrier film at a predetermined thickness to form a tape material having a solvent;
initiating nucleation of the solvent from a liquid phase to a solid phase at a plurality of discrete locations in the tape material by moving the carrier film and the tape material through a nucleation zone having a nucleation heat flux applied by a first cooling component;
freezing the solvent from at least one of the plurality of discrete locations in a growth direction through the thickness of the tape material by moving the carrier film and the tape material through a steady growth zone having a steady growth heat flux applied by a second cooling component, wherein the applied steady growth heat flux is different from the applied nucleation heat flux; and
removing the solvent from the tape material to leave pores oriented along the growth direction in the tape material.

10. The method of claim 9, wherein frozen solvent is removed from the tape material by sublimation.

11. The method of claim 9, further comprising:
detecting, by a temperature sensor, a temperature of the nucleation zone used to determine an initial nucleation heat flux;
determining, by a control unit, a final nucleation heat flux based on the solvent of the tape material and the thickness of the tape material; and
causing, by the control unit, a cooling system to change the initial nucleation heat flux to the final nucleation heat flux.

12. The method of claim 9, further comprising:
providing at least one roller in operable communication with a control unit, wherein the at least one roller is connected to the carrier film to move the carrier film in the production direction;
receiving, by the control unit, an initial rotation speed of the at least one roller;
determining, by the control unit, a final rotation speed of the at least one roller such that the carrier film moves at a predetermine rate, and a given point of the tape material moves through the nucleation zone for a nucleation dwell time and moves through the steady growth zone for a steady growth dwell time; and
causing, by the control unit, the at least one roller to change the initial rotation speed to the final rotation speed.

13. The method of claim 9, further comprising:
detecting, by a temperature sensor, an initial temperature of an ambient gas above the carrier film and the tape material;
determining, by a control unit, a final temperature based on the solvent of the tape material and the thickness of the tape material; and
causing, by the control unit, an ambient control unit to change the initial temperature to the final temperature and establish the nucleation heat flux through the thickness of the tape material in the nucleation zone and the steady growth heat flux through the tape material in the steady growth zone.

14. A freeze tape casting system, comprising:
a control unit programmed to independently control a temperature profile of a first zone and a temperature profile of a second zone;
a first temperature sensor in operable communication with the control unit, the first temperature sensor detects a temperature that is part of an initial first temperature profile in the first zone;
a second temperature sensor in operable communication with the control unit, the second temperature sensor detects a temperature that is part of an initial second temperature profile in the second zone;
a cooling system in operable communication with the control unit, the cooling system positioned beneath a carrier film in the first and second zones;
instructions that, when executed by the control unit, cause the control unit to:
receive the temperature that is part of the initial first temperature profile in the first zone;
determine a final first temperature profile based on a solvent in a tape material on the carrier film;
cause the cooling system to change the initial first temperature profile to the final first temperature profile in the first zone;
receive the temperature that is part of the initial second temperature profile in the second zone;
determine a final second temperature profile based on the solvent in the tape material on the carrier film;
cause the cooling system to change the initial second temperature profile to the final second temperature profile in the second zone.

15. The freeze tape casting system of claim 14, wherein the cooling system comprises a first coolant loop positioned beneath the carrier film in the first zone and a second coolant loop positioned beneath the carrier film in the second zone.

16. The freeze tape casting system of claim 14, wherein the first zone is a nucleation zone, and the final first temperature profile initiates nucleation of the solvent from a liquid phase to a solid phase at a plurality of discrete locations in the tape material, wherein the second zone is a steady growth zone, and the final second temperature profile continues freezing of the solvent from at least one of the plurality of discrete locations in a growth direction through a thickness of the tape material.

17. The freeze tape casting system of claim 14, further comprising:
an ambient temperature sensor in operable communication with the control unit; the ambient temperature sensor detects an initial ambient temperature of an ambient gas above the carrier film and the tape material;
an ambient control unit in operable communication with the control unit, the ambient control unit positioned above the carrier film and the tape material;
instructions that, when executed, cause the control unit to:
receive the initial ambient temperature from the ambient temperature sensor;
determine a final ambient temperature based on the solvent in the tape material on the carrier film;
cause the ambient control unit to change the initial ambient temperature of the ambient gas to the final ambient temperature of the ambient gas and establish a first temperature gradient through the thickness of the tape material in the first zone and a second temperature gradient through the tape material in the second.

18. The freeze tape casting system of claim 14, wherein the control unit determines the initial first temperature profile.

19. The freeze tape casting system of claim 14, further comprising:
at least one roller in operable communication with the control unit, wherein the at least one roller is connected to the carrier film to move the carrier film in a production direction;
instructions that, when executed, cause the control unit to:
receive an initial roller speed from the at least one roller;
determine a final roller speed based on the solvent in the tape material on the carrier film;
cause the at least one roller to change the initial roller speed to the final roller speed.

20. The freeze tape casting system of claim 14, further comprising:
instructions that, when executed, cause the control unit to:
receive the final first temperature profile;
determine a dwell time for the tape material in the first zone;
cause the cooling system to change an axial length of the first zone along a production direction.
